(19) United States
(12) Patent Application Publication
(10) Pub. No.: US 2016/0139907 A1
(43) Pub. Date: May 19, 2016

(54) ELECTRONIC DEVICE AND METHOD FOR CONTROLLING ELECTRONIC DEVICE

(71) Applicant: KYOCERA Corporation, Kyoto-shi (JP)

(72) Inventors: Toshiyuki KUMANO, Osaka (JP); Atsutaka SAIKI, San Diego, CA (US)

(73) Assignee: KYOCERA Corporation

(21) Appl. No.: 15/005,677

(22) Filed: Jan. 25, 2016

Related U.S. Application Data
(63) Continuation of application No. PCT/JP2014/069680, filed on Jul. 25, 2014.

(30) Foreign Application Priority Data
Jul. 25, 2013 (JP) 2013-154950

(51) Int. Cl. G06F 9/445; H04L 29/08

(52) U.S. Cl. CPC G06F 8/62; H04L 67/34

(57) ABSTRACT

A mobile phone includes a display, a memory and a deletion control. The deletion control unit is configured to, when a tap operation is performed on a deletion icon attached to a start-up icon, extract a deletion candidate application relevant to a deletion target application on which a tap operation has been performed based on information in an application information table stored in the memory unit. The deletion control unit is configured to delete the deletion target application and to delete the extracted deletion candidate application.

### CROSS-REFERENCE TO RELATED APPLICATION

The present application is a continuation based on PCT Application No. PCT/JP2014/069680 filed on Jul. 25, 2014, which claims the benefit of Japanese Application No. 2013-154950, filed on Jul. 25, 2013. PCT Application No. PCT/JP2014/069680 is entitled “Electronic Device and Method for Controlling Electronic Device”, and Japanese Application No. 2013-154950 is entitled “Electronic Device, Program and Method for Controlling Electronic Device.” The content of which are incorporated by reference herein in their entirety.

### FIELD

The present disclosure relates to an electronic device, such as a mobile phone, a personal computer, a PDA (Personal Digital Assistant), a tablet PC, or a digital book terminal. The present disclosure also relates to a control method suitable for use in such an electronic device.

### BACKGROUND

A mobile phone conventionally known executes various types of application programs (hereinafter briefly referred to as “applications”) based on touch operations on a touch panel.

In such a mobile phone, when a predetermined touch operation is performed on a desired start-up icon for executing an application displayed on a display, a screen for confirming whether or not deletion of an application corresponding to the selected start-up icon may be executed is displayed on the display. By performing an operation of approving deletion on the screen for confirming deletion of the application, the application targeted for the deletion operation is deleted from the mobile phone.

### SUMMARY

In one embodiment, an electronic device includes a memory configured to store applications comprising a first application and one or more second applications and at least one processor configured to select the first application, identify the one or more second applications relevant to the first application delete the first application, and delete the one or more second applications when the first application is deleted.

In one embodiment, an electronic device includes a display, a memory configured to store applications comprising a first application and one or more second applications and at least one processor. The at least one processor is configured to select the first application, identify the one or more second applications relevant to the first application, delete the first application, and delete the one or more second applications when the first application is deleted. The at least one processor is configured to cause the display to display a first screen including a first object operated to start up the first application and one or more second objects operated to start up the one or more second applications. The at least one processor is configured to delete the first object and the one or more second objects following deletion of the first application and the one or more second applications.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIGS. 1A to 1C show a configuration of a mobile phone according to one embodiment.

FIG. 2 is a block diagram showing an overall configuration of the mobile phone according to one embodiment.

FIGS. 3A and 3B show an application information table and a deletion candidate registration table according to one embodiment.

FIGS. 4A and 4B illustrate explanatory drawings of screens displayed on a display by execution of an application according to one embodiment.

FIG. 5 is a flowchart showing an application deletion process according to one embodiment.

FIG. 6 is a flowchart showing a deletion candidate extraction process according to one embodiment.

FIG. 7 shows a display example of an application deletion screen according to one embodiment.

FIG. 8 shows a display example of the application deletion screen according to one embodiment.

FIGS. 9A and 9B show a flowchart of a deletion candidate extraction process and a deletion candidate registration table according to one embodiment.

FIGS. 10A and 10B show a flowchart of a deletion candidate extraction process and a deletion candidate registration table according to one embodiment.

FIGS. 11A and 11B show a flowchart of a deletion candidate extraction process and a deletion candidate registration table according to one embodiment.

FIGS. 12A and 12B show a display example of a home screen according to one variation.

FIG. 13 is a flowchart showing an icon deletion process according to one variation.

FIG. 14 shows a display example of an icon deletion screen according to one variation.

FIGS. 15A and 15B show a display example of a home screen and an application setting screen according to one variation.

FIG. 16 is a flowchart showing an application deletion process according to one variation.

FIG. 17 shows a display example of an application deletion screen according to one variation.

FIG. 18 is a flowchart showing an application deletion process according to one variation.

FIG. 19 is a flowchart showing a deletion candidate selection process according to one variation.

FIG. 20 shows a display example of an application deletion screen according to one variation.

### DETAILED DESCRIPTION

Hereinafter, embodiments will be described with reference to the drawings.

In a background art mobile phone, when a user intends to delete a plurality of applications or start-up icons, he/she needs to repeat the above-described deletion operation. The above-described mobile phone requires a user to perform complicated work for deleting a plurality of applications or start-up icons. By repeating such a simple deletion operation several times, an unintended application or start-up icon might be deleted by mistake.

The above-described problem is solved by the present disclosure.

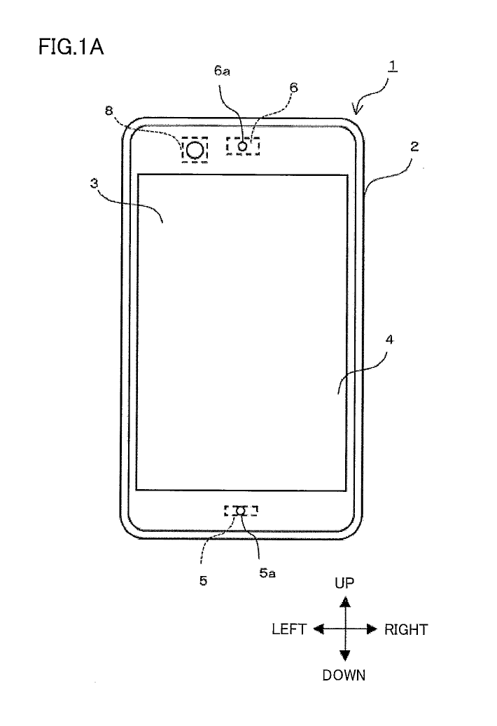

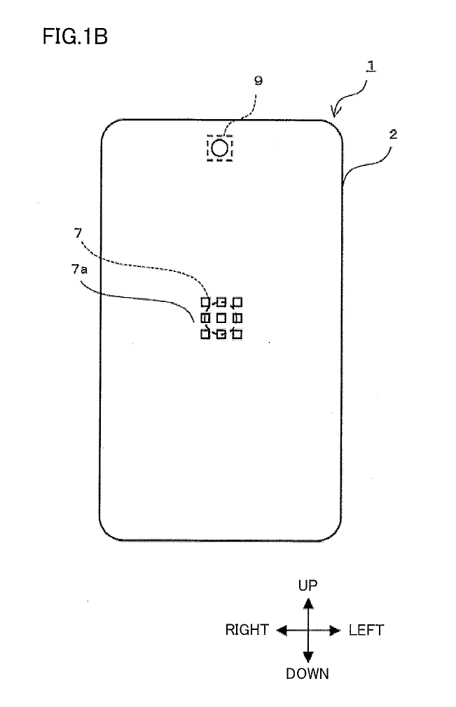

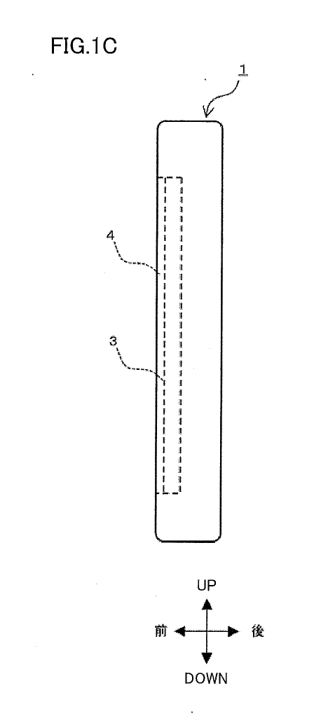

FIGS. 1A to 1C show a front view, a rear view and a right side view of a mobile phone 1, respectively. Hereinafter, as shown in FIGS. 1A to 1C, the longitudinal direction of a cabinet 2 is defined as the up/down direction, and the shorter direction of cabinet 2 is defined as the left/right direction, for ease of description.

As shown in FIGS. 1A to 10, mobile phone 1 includes cabinet 2, a display 3, a touch panel 4, a microphone 5, a conversation speaker 6, and an external speaker 7.

Cabinet 2 has a substantially rectangular profile as seen from the front surface. Display 3 is arranged on the front surface side of cabinet 2. Various types of images (screens) can be displayed on display 3. Display 3 is a liquid crystal display, for example. Display 3 may be a display of another type, such as an organic electroluminescence display. Touch panel 4 is arranged on the surface of display 3 where an image is displayed. Touch panel 4 may be formed as a transparent sheet. As touch panel 4, various types of touch panels, such as capacitance type, ultrasonic type, pressure-sensitive type, resistive film type, and optical sensing type touch panels, may be used.

Microphone 5 may be arranged at the lower end within cabinet 2. Conversation speaker 6 may be arranged at the upper end within cabinet 2. Microphone 5 can receive voice passed through a microphone hole 5a formed in the front surface of cabinet 2. Microphone 5 can generate an electrical signal in accordance with received sound. Conversation speaker 6 can output sound. The output sound can be emitted out of cabinet 2 through an output hole 6a formed in the front surface of cabinet 2. At the time of a call, received voice from a device of a communication partner (mobile phone etc.) can be output through conversation speaker 6, and user's uttered voice can be input to microphone 5. The sound includes various types of sound, such as voice and an audible alert.

External speaker 7 may be arranged within cabinet 2. An output hole 7a may be formed in the rear surface of cabinet 2 in a region facing external speaker 7. Sound output through external speaker 7 can be emitted out of cabinet 2 through output hole 7a.

At the upper part of cabinet 2, an internal camera 8 may be arranged on the front surface side, and an external camera 9 may be arranged on the rear surface side. Internal camera 8 can capture an image of a subject present in the direction of the front surface of mobile phone 1. External camera 9 can capture an image of a subject present in the direction of the rear surface of mobile phone 1.

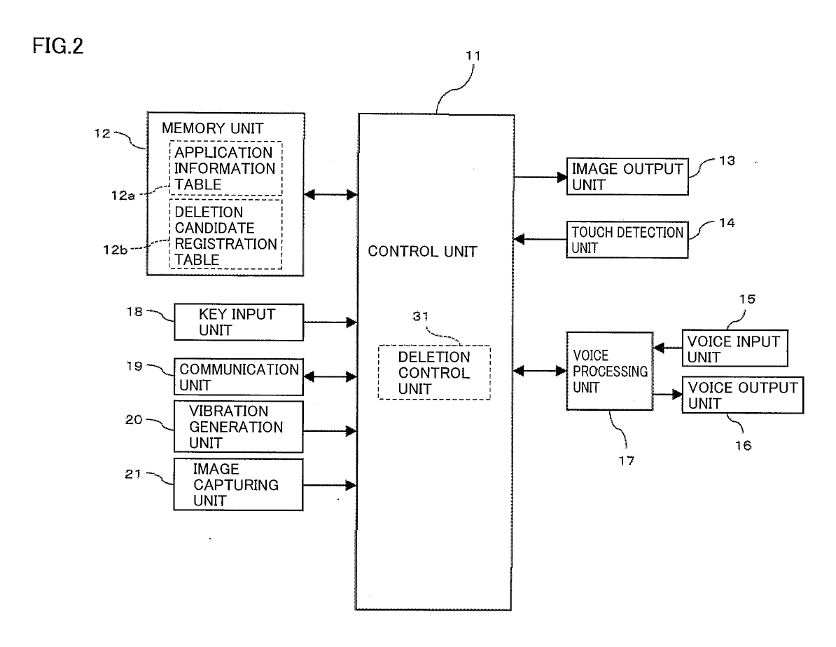

FIG. 2 is a block diagram showing an overall configuration of mobile phone 1.

As shown in FIG. 2, mobile phone 1 includes a control unit 11, a memory unit 12, an image output unit 13, a touch detection unit 14, a voice input unit 15, a voice output unit 16, a voice processing unit 17, a key input unit 18, a communication unit 19, a vibration generation unit 20, and an image capturing unit 21.

Memory unit 12 can include ROM, RAM, and an external memory. Memory unit 12 may store various types of programs. The programs stored in memory unit 12 include various applications (e.g., telephone, e-mail, web browser, map, game, schedule management, etc.) in addition to a control program for controlling each unit of mobile phone 1. The programs are stored in memory unit 12 by a manufacturer during manufacture of mobile phone 1, or may be stored in memory unit 12 through a communication network or storage medium, such as a memory card or CD-ROM.

Memory unit 12 may also include a working area for storing data temporarily utilized or generated while a program is executed.

Memory unit 12 may have stored therein an application information table 12a and a deletion candidate registration table 12b.

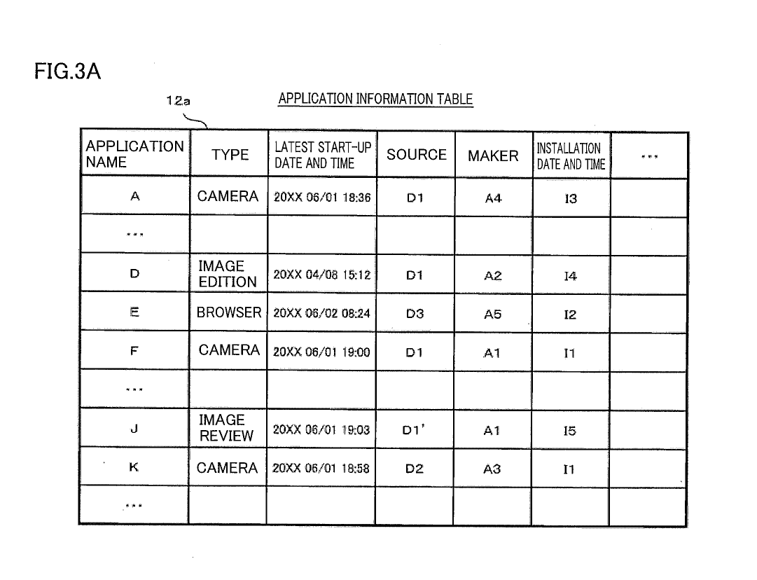

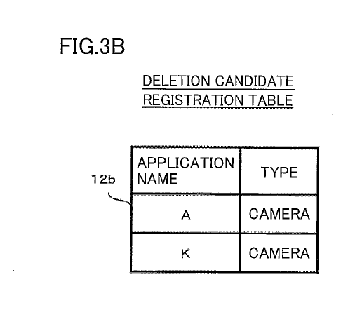

FIG. 3A shows application information table 12a and FIG. 3B shows deletion candidate registration table 12b.

As shown in FIG. 3A, application information table 12a may have registered therein various types of information on each application installed in memory unit 12. The various types of information on each application installed may include application name, application type, latest start-up date and time, source (from which each application has been downloaded), maker, installation date and time (if upgraded, upgraded date and time), as well as other types of information related to each application. The other information includes the version, size and the like of each application. These pieces of information may be registered or updated when each application is installed or used.

As shown in FIG. 3B, the name and type of a deletion candidate application may be registered in deletion candidate registration table 12b. A deletion candidate application is an application which will be a candidate for an application to be deleted together with a predetermined application when deleted by a user. A deletion candidate application relates to an application to be deleted. When a user deletes a predetermined application, control unit 11 may register information (name and type) of a deletion candidate application that meets deletion candidate extraction conditions which will be described later. Deletion candidate registration table 12b should just register information for specifying an application to be a deletion candidate, and the example shown in FIG. 3B is not a limitation. For example, ID for specifying each application may be registered.

Returning to FIG. 2, control unit 11 includes CPU (Central Processing Unit). In accordance with programs stored in memory unit 12, CPU can control respective units constituting mobile phone 1 (memory unit 12, image output unit 13, touch detection unit 14, voice input unit 15, voice output unit 16, voice processing unit 17, key input unit 18, communication unit 19, vibration generation unit 20, and image capturing unit 21, and the like).

Image output unit 13 may include display 3 shown in FIGS. 1A to 1C. Image output unit 13 can cause display 3 to display an image (screen) based on a control signal and an image signal received from control unit 11. Image output unit 13 can turn on, turn off, and adjust brightness of, display 3 in response to control signals received from control unit 11.

Touch detection unit 14 can include touch panel 4 shown in FIGS. 1A to 1C, and can detect a touch operation on touch panel 4. More specifically, touch detection unit 14 can detect a contact position (hereinafter referred to as a “touch position”) at which a contact object, such as a user's finger or a touch pen (hereinafter referred to as a finger), contacts touch panel 4. Touch detection unit 14 can output a position signal generated based on a detected touch position to control unit 11.

The touch operation can include a tap operation, a flick operation, a sliding operation, and the like, for example. The tap operation is an operation of contacting touch panel 4 with a finger, and then lifting the finger from touch panel 4 after a short period of time. The flick operation is an operation of contacting touch panel 4 with a finger, and then flicking the finger on touch panel 4 in any direction. The sliding operation is an operation of moving a finger in any direction with the finger kept in contact with touch panel 4. The long tap operation is an operation of contacting touch panel 4 with a finger, then maintaining the contact for a while, and lifting the finger from touch panel 4.

For example, in the case where touch detection unit 14 detects a touch position, when the touch position is no longer detected within a predetermined first time after the touch position is detected, control unit 11 can determine that the touch operation is a tap operation. In the case where a touch position is moved by a predetermined first distance or more within a predetermined second time after the touch position is detected, and then the touch position is no longer detected, control unit 11 can determine that the touch operation is a flick operation. When a touch position is moved by a predetermined second distance after the touch position is detected, control unit 11 can determine that the touch operation is a sliding operation.

Voice input unit 15 can include microphone 5. Voice input unit 15 can output an electrical signal from microphone 5 to voice processing unit 17.

Voice output unit 16 can include conversation speaker 6 and external speaker 7. An electrical signal received from voice processing unit 17 can be input to voice output unit 16. Voice output unit 16 can cause sound to be output through conversation speaker 6 or external speaker 7.

Voice processing unit 17 can perform A/D conversion or the like on an electrical signal received from voice input unit 15, and can output a digital audio signal after conversion to control unit 11. Voice processing unit 17 can perform decoding and D/A conversion or the like on a digital audio signal received from control unit 11, and can output an electrical signal after conversion to voice output unit 16.

Key input unit 18 can include at least one or more hard keys. For example, key input unit 18 can include a power key for switching between on and off of mobile phone 1, and the like. Key input unit 18 can output a signal corresponding to a pressed hard key to control unit 11.

Communication unit 19 can include a circuit for converting a signal, an antenna that transmits/receives electric waves, and the like, in order to make calls and communications. Communication unit 19 can convert a signal for a call or communication received from control unit 11 into a radio signal, and can transmit the converted radio signal to a communication destination, such as a base station or another communication device, through the antenna. Communication unit 19 can convert a radio signal received through the antenna into a signal in the form that can be utilized by control unit 11, and can output the converted signal to control unit 11.

Vibration generation unit 20 can include a vibrator. Vibration generation unit 20 can vibrate the vibrator based on a control signal received from control unit 11. Vibration of the vibrator is transferred to cabinet 2, and cabinet 2 vibrates.

Image capturing unit 21 can include internal camera 8 shown in FIG. 1A and external camera 9 shown in FIG. 1B. Image capturing unit 21 can perform various types of image processing on image data of images captured by internal camera 8 and external camera 9, and can output image data after image processing to control unit 11.

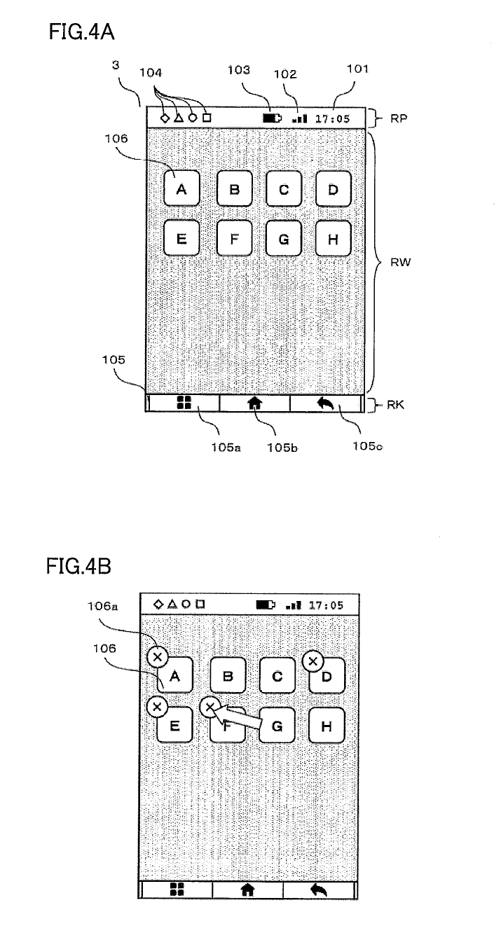

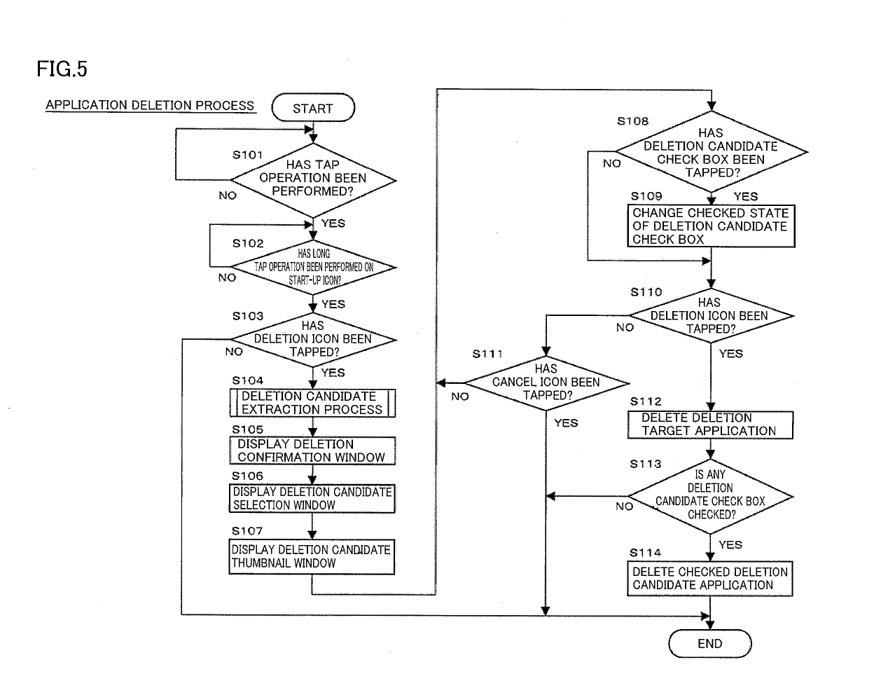

FIGS. 4A and 4B illustrate explanatory drawings of screens displayed on display 3 by execution of an application. As described above, control unit 11 can execute various types of applications, and can cause display 3 to display a screen in accordance with each application.

As shown in FIG. 4A, the screen displayed on display 3 is composed of a pictogram region RP, a window region RW and a key region RK. A current time 101, a strength meter 102 indicating the strength of received electric waves, and a capacity meter 103 indicating the battery capacity can be displayed in pictogram region RP. Notification icons 104 corresponding to various types of notification information, such as missed call information and new message information can also be displayed in pictogram region RP. A user can confirm the type of notification information by confirming notification icons 104. When a user performs a predetermined operation, a list screen of notification information which will be described later can be displayed on display 3.

An operation key group 105 can be displayed in key region RK. Operation key group 105 is composed of a setting key 105a, a home key 105b and a back key 105c. Setting key 105a is a key mainly for causing display 3 to display a setting screen for performing various types of setting. Home key 105b is a key mainly for causing the display of display 3 to shift to a home screen from another screen. Back key 105c is a key mainly for returning an executed process to a process in an immediately preceding step.

An execution screen of an application can be displayed in window region RW. For example, as shown in FIG. 4A, when a home application is executed, a home screen can be displayed in window region RW. On the home screen, start-up icons 106 corresponding to various types of applications for telephone, e-mail and the like are arranged. When a predetermined touch operation, for example, a tap operation is performed on start-up icon 106, an application associated with start-up icon 106 can be executed.

Depending on an application executed, window region RW may be extended to at least one of pictogram region RP and key region RK.

When a long tap operation is performed on any start-up icon 106, a deletion icon 106a can be attached to the upper left corner of each start-up icon 106 that can be deleted, as shown in FIG. 4B. By performing a tap operation on deletion icon 106a, the application associated with start-up icon 106 can be deleted. As described above, deletion icon 106a can be attached only to an application that can be deleted. For example, it is possible to avoid deletion icons 106a being attached to applications of basic functions, such as telephone and e-mail.

In one embodiment, mobile phone 1 includes an application for deleting a plurality of applications collectively in a simple operation. An application to be deleted by performing a tap operation on deletion icon 106a will be hereinafter referred to as a “deletion target application.” An application relevant to a deletion target application extracted by control unit 11 will be referred to as a “deletion candidate application.”

Control unit 11 can execute a control process for deletion of a deletion target application and a deletion candidate application (hereinafter referred to as an “application deletion process”) and a control process for extraction of a deletion candidate application (hereinafter referred to as a “deletion candidate extraction process”). As shown in FIG. 2, control unit 11 can include a deletion control unit 31 for executing the application deletion process and the deletion candidate extraction process. Deletion control unit 31 can be implemented as a function for a program executed by control unit 11.

Deletion control unit 31 can read various types of information from application information table 12a, and can extract a deletion candidate application relevant to a deletion target application. Deletion control unit 31 can cause display 3 to display a screen for a user to select whether or not a deletion candidate application is to be deleted together with a deletion target application. Deletion control unit 31 can delete a deletion target application and a deletion candidate application collectively in response to a user operation.

Specific examples of the application deletion process and the deletion candidate extraction process will be described below.

In one embodiment, a deletion candidate application can be extracted based on information on the type of applications stored in application information table 12a. In one embodiment, being of the type identical to that of the deletion target application shall be a deletion candidate extraction condition for extracting a deletion candidate application. In one embodiment, an application relevant to a deletion target application identified by control unit 11 may be referred to as a “deletion candidate application.

FIG. 5 is a flowchart showing the application deletion process according to one embodiment.

Referring to FIG. 5, deletion control unit 31 can determine whether or not a long tap operation has been performed on start-up icon 106 (S101). When a long tap operation has not been performed on start-up icon 106 (NO in S101), deletion control unit 31 can repeat processing of determining whether or not a long tap operation has been performed on start-up icon 106. When a long tap operation has been performed on start-up icon 106 (YES in S101), deletion control unit 31 can determine whether or not a tap operation has been performed on window region RW (S102).

When a tap operation has not been performed on window region RW (NO in S102), deletion control unit 31 can repeat the processing of determining whether or not a tap operation has been performed on window region RW. When a tap operation has been performed on window region RW (YES in S102), deletion control unit 31 can determine whether or not the tap operation performed on window region RW is a tap operation on deletion icon 106a (S103). When it is not a tap operation on deletion icon 106a (NO in S103), deletion control unit 31 terminates the application deletion process. When the process is terminated, the application deletion process is executed again, and the processing of determining whether or not a long tap operation has been performed on start-up icon 106 (S101) is executed.

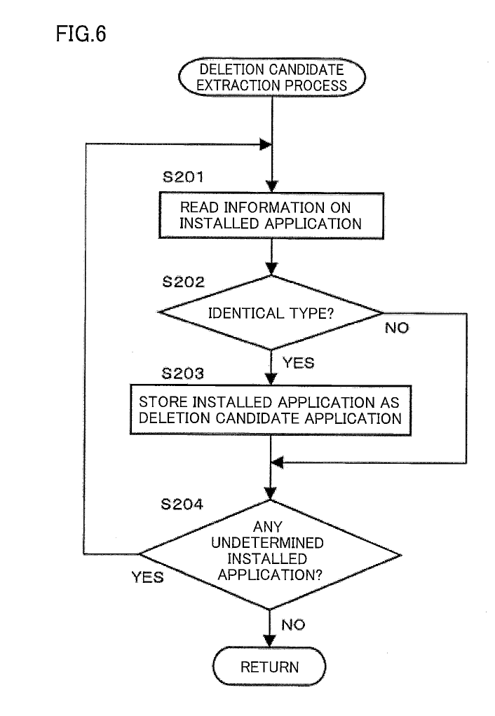

When the tap operation performed on window region RW is a tap operation on deletion icon 106a (YES in S103), deletion control unit 31 can execute the deletion candidate extraction process shown in FIG. 6 (S104).

FIG. 6 is a flowchart showing the deletion candidate extraction process according to one embodiment.

Referring to FIG. 6, deletion control unit 31 can read information on the name and type of an installed application from application information table 12a (S201). Deletion control unit 31 can determine whether or not the type of a deletion target application corresponding to deletion icon 106a on which a tap operation has been performed is identical to the type of the installed application having been read (S202).

When the type of the deletion target application is identical to that of the installed application having been read (YES in S202), deletion control unit 31 can store the name and type of this application in deletion candidate registration table 12b (S203). When the type of the deletion target application is not identical to that of the installed application having been read (NO in S202), deletion control unit 31 advances the process to S204.

Deletion control unit 31 can determine whether or not an installed application not having been determined as to whether or not it is of the identical type is registered in application information table 12a (S204). When an undetermined installed application is registered (YES in S204), deletion control unit 31 can return the process to S201 to execute the processing of determining whether or not all of installed applications are of the type identical to that of a deletion candidate application (S201 to S204). When there is no undetermined installed application (NO in S204), deletion control unit 31 advances the process to S105 in FIG. 5.

For example, in application information table 12a shown in FIG. 3A, if a deletion target application is “F”, applications “A” and “K” whose type is “camera” can be registered in deletion candidate registration table 12b shown in FIG. 3B. Applications of basic functions for which a user is not authorized to delete will not be extracted as deletion candidates.

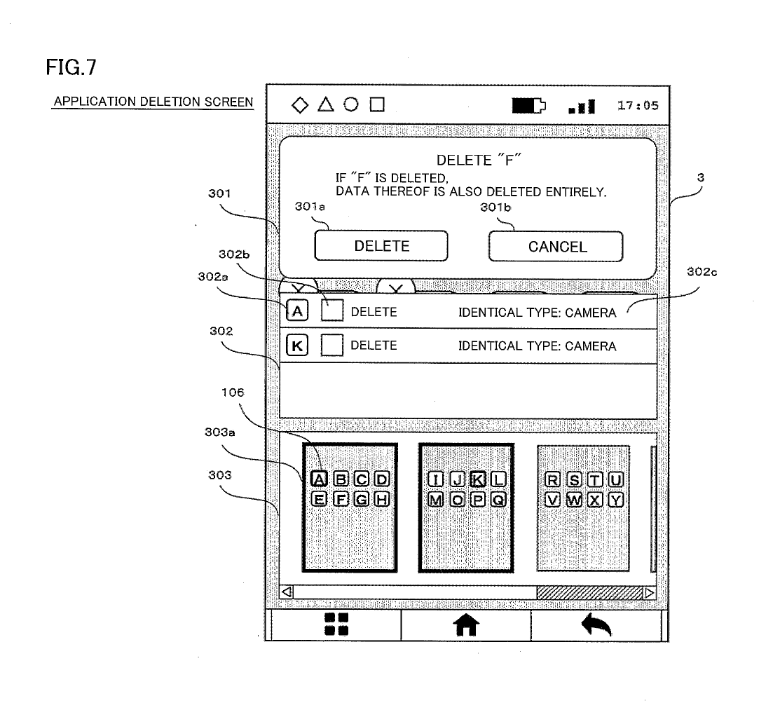

Referring back to FIG. 5, deletion control unit 31 can cause display 3 to display a deletion confirmation window 301, a deletion candidate selection window 302 and a deletion candidate thumbnail window 303, as shown in FIG. 7 (S105 to S107).

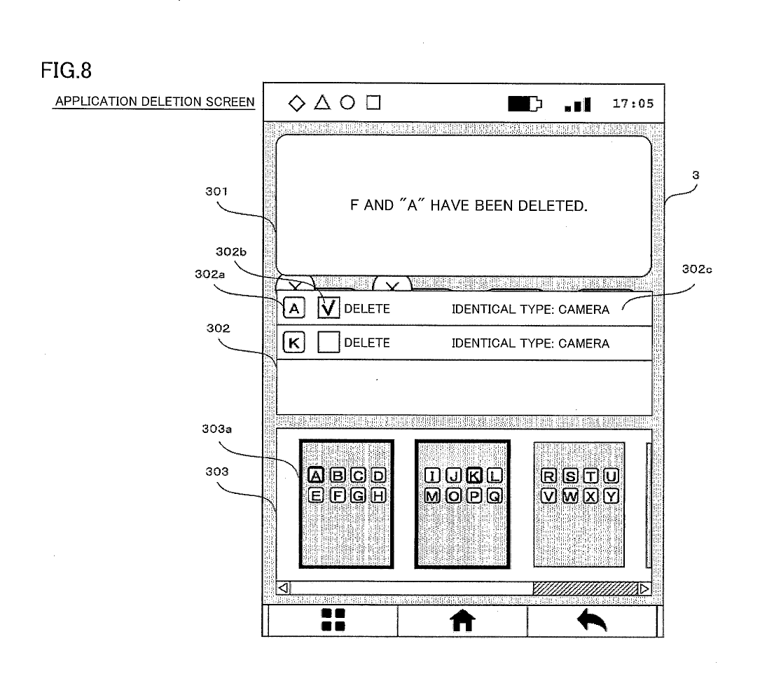

FIGS. 7 and 8 each show a display example of the application deletion screen according to one embodiment.

Referring to FIG. 7, the application deletion screen may include deletion confirmation window 301, deletion candidate selection window 302 and deletion candidate thumbnail window 303. Deletion confirmation window 301 may include a message that confirms whether or not a deletion target application is to be deleted, a deletion icon 301a and a cancel icon 301b. A user can confirm the name of a deletion target application by looking at deletion confirmation window 301. In the example of FIG. 7, “F” is shown as the name of a deletion target application.

Deletion candidate selection window 302 may include a deletion candidate icon 302a, a deletion candidate check box 302b and an extraction reason message 302c. The name of a deletion candidate application extracted by the above-described deletion candidate extraction process (S201 to S204) is displayed on deletion candidate icon 302a. In the example of FIG. 7, “A” and “F” are shown as the name of deletion candidate applications.

By performing a tap operation on deletion candidate check box 302b, whether or not deletion of a deletion candidate application is necessary may be selected. Extraction reason message 302c is a character string indicating the reason that the deletion candidate application has been extracted. The example of FIG. 7 shows that the reason for deletion candidate extraction is being of “identical type”, and shows that the type is “camera.”

Deletion candidate thumbnail window 303 may include a plurality of deletion candidate thumbnails 303a. Each deletion candidate thumbnail 303a is an image obtained by scaling down each page of the home screen, and start-up icon 106 of each deletion candidate application is highlighted. By looking at deletion candidate thumbnail 303a, a user can easily understand at which position on the home screen a deletion candidate application is located, and can promptly determine whether or not deletion of the deletion candidate application is necessary.

Referring back to FIG. 5, deletion control unit 31 can determine whether or not a tap operation has been performed on deletion candidate check box 302b (S108). When a tap operation has been performed on deletion candidate check box 302b (YES in S108), deletion control unit 31 can change the checked state of deletion candidate check box 302b (S109). Specifically, when deletion candidate check box 302b is not in the checked state, deletion control unit 31 can store flag information that brings deletion candidate check box 302b into the checked state, in memory unit 12. A check mark may be displayed in deletion candidate check box 302b. When deletion candidate check box 302b is in the checked state, deletion control unit 31 can store flag information that brings deletion candidate check box 302b into the unchecked state, in memory unit 12. The check mark may be deleted from deletion candidate check box 302b. When a tap operation has not been performed on deletion candidate check box 302b (NO in S108), deletion control unit 31 advances the process to S110.

Deletion control unit 31 can determine whether or not a tap operation has been performed on deletion icon 301a in deletion confirmation window 301 (S110). When a tap operation has not been performed on deletion icon 301a (NO in S110), deletion control unit 31 can determine whether or not a tap operation has been performed on cancel icon 301b in deletion confirmation window 301 (S111). When a tap operation has not been performed on cancel icon 301b (NO in S111), deletion control unit 31 can return the process to S108 to repeat the processing of determining whether or not tap operations have been performed on deletion candidate check box 302b in deletion candidate selection window 302 as well as deletion icon 301a and cancel icon 301b in deletion confirmation window 301 (S108 to S111). When a tap operation has been performed on cancel icon 301b (YES in S111), deletion control unit 31 can terminate the application deletion process. When the process is terminated, the application deletion process can be executed again to execute the processing of determining whether or not a tap operation has been performed on start-up icon 106 (S101).

When a tap operation has been performed on deletion icon 301a (YES in S110), deletion control unit 31 can delete a deletion target application (S112). Specifically, deletion control unit 31 can delete a program, a configuration file and the like of a deletion target application from memory unit 12 to delete information on the deletion target application from application information table 12a. Start-up icon 106 of the deletion target application can thereby be deleted from the home screen.

Deletion control unit 31 can determine whether or not any of deletion candidate check boxes 302b is in the checked state (S113). When any of deletion candidate check boxes 302b is in the checked state (YES in S113), deletion control unit 31 can delete the deletion candidate application in the checked state (S114). Specifically, deletion control unit 31 can delete a program, a configuration file and the like of the deletion candidate application from memory unit 12 to delete information on the deletion candidate application from application information table 12a. Start-up icon 106 of the deletion candidate application can thereby be deleted from the home screen. When none of deletion candidate check boxes 302b is in the checked state (NO in S113), deletion control unit 31 terminates the application deletion process. When the process is terminated, the application deletion process may be executed again to execute the processing of determining whether or not a tap operation has been performed on start-up icon 106 (S101).

When the deletion target application and the deletion candidate application whose deletion candidate check box 302b is in the checked state are thus deleted, the name of applications having been deleted can be displayed on the application deletion screen, as shown in FIG. 8.

As described above, according to one embodiment, deletion control unit 31 can extract a deletion candidate application relevant to a deletion target application, and can automatically delete the deletion candidate application after the deletion target application is deleted. A user can delete a plurality of applications in a simple operation. This can restrain repetition of a simple deletion operation, and can prevent erroneous deletion of an application.

According to one embodiment, as shown in FIG. 7, whether or not deletion of a deletion candidate application is necessary can be selected by deletion candidate check box 302b. A user can appropriately determine whether or not deletion of a deletion candidate application is necessary.

According to one embodiment, deletion candidate thumbnail 303a is displayed as shown in FIG. 7. A user can readily identify at which position on the home screen a deletion candidate application is located, and can promptly determine whether or not deletion of the deletion candidate application is necessary.

According to one embodiment, extraction reason message 302c is displayed as shown in FIG. 7. A user can identify for what reason a deletion candidate application has been extracted. Whether or not deletion of the deletion candidate application is necessary can thereby be determined properly.

According to one embodiment, deletion candidate selection window 302 is displayed before deletion of a deletion target application, and the deletion target application and the deletion candidate application can be deleted collectively. The processing for deleting the applications can be performed efficiently.

According to one embodiment, a deletion candidate application is extracted based on information on the type of a deletion target application. An installed application of the type identical to that of the deletion target application can be reliably extracted as a deletion candidate.

In one embodiment, an application of the type identical to that of the deletion target application is extracted as a deletion candidate application, but the application may not necessarily be of the identical type. For example, an application belonging to the category identical to that of a deletion target application may be extracted as a deletion candidate. For example, the application of “camera” and the application of “image review” may be assumed to belong to the same category.

In one embodiment, a deletion candidate application is extracted based on the information on the type of application. In one embodiment, a deletion candidate application may be extracted based on information on the latest start-up date and time of each application stored in application information table 12a. In one embodiment, that the latest start-up date and time is close to (falls within a predetermined time period from) that of a deletion target application shall be a deletion candidate extraction condition for extracting a deletion candidate application.

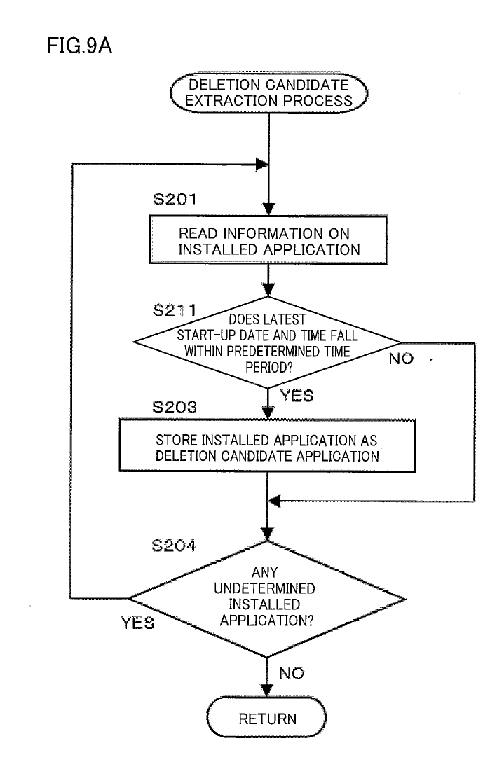

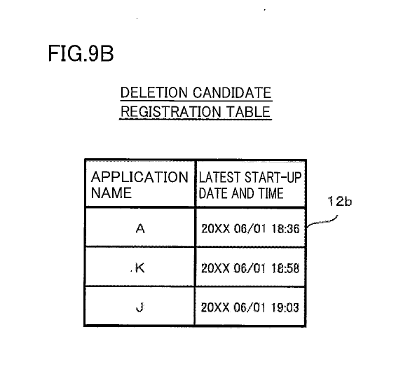

FIG. 9A shows a flowchart of a deletion candidate extraction process according to one embodiment, and FIG. 9B shows an example of deletion candidate registration table 12b according to one embodiment.

Referring to FIG. 9A, deletion control unit 31 can read information on the name and latest start-up date and time of an installed application from application information table 12a (S201). Deletion control unit 31 can determine whether or not the latest start-up date and time of a deletion target application corresponding to deletion icon 106a on which a tap operation has been performed falls within a predetermined time period from the latest start-up date and time of the installed application having been read (S211). For example, the predetermined time period is set at approximately several minutes to several tens of minutes.

When the latest start-up date and time of a deletion target application falls within the predetermined time period from the latest start-up date and time of the installed application having been read (YES in S211), deletion control unit 31 can store the name and latest start-up date and time of this application in deletion candidate registration table 12b (S203). When the latest start-up date and time of a deletion target application does not fall within the predetermined time period from the latest start-up date and time of the installed application having been read (NO in S211), deletion control unit 31 advances the process to S204.

Similarly to one embodiment, deletion control unit 31 can return the process to S201 to execute extraction of deletion candidates for all installed applications (S201 to S204).

For example, if a deletion target application is “F” in application information table 12a shown in FIG. 3A, applications “A”, “K” and “J” whose latest start-up date and time is close to that of the application “F” can be registered in deletion candidate registration table 12b shown in FIG. 9B.

As described above, according to one embodiment, a deletion candidate application may be extracted based on the latest start-up date and time of a deletion target application. An installed application utilized in connection with the deletion target application may be extracted as a deletion candidate. For example, the image review application “J” which is likely to be utilized together with the camera application “F” may also be extracted as a deletion candidate. A user can delete applications relevant to the deletion target application collectively.

In one embodiment, a deletion candidate application is extracted by comparing the latest start-up date and time of a deletion target application with those of an installed application, but this is not a limitation. For example, a deletion candidate application may be extracted based not only on the comparison of the latest start-up date and time of applications, but also on the statistics of the start-up date and time of a predetermined number of times in the past. Deletion candidate extraction can thereby be improved in accuracy although the capacity necessary for memory unit 12 will be increased because of the necessity for storing the start-up date and time by a predetermined number of times in addition to the latest start-up date and time.

In one embodiment, a deletion candidate application may be extracted based on information on a source of an application stored in application information table 12a. In one embodiment, being obtained from a source identical to that of a deletion target application shall be a deletion candidate extraction condition for extracting a deletion candidate application.

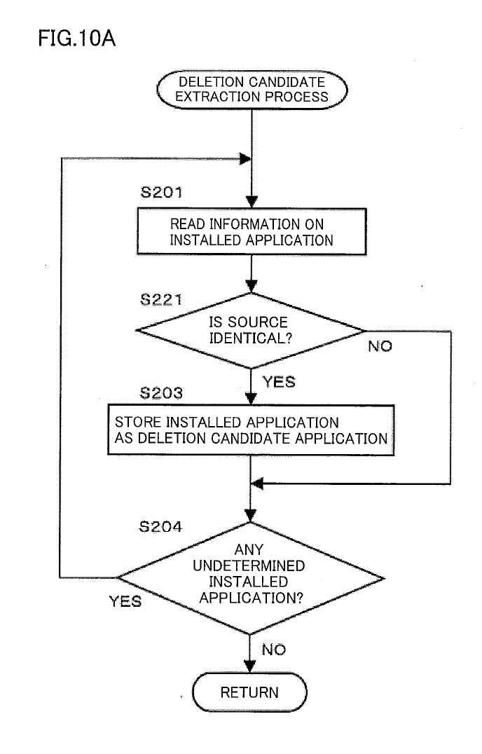

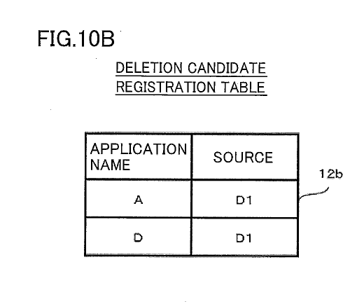

FIG. 10A shows a flowchart of a deletion candidate extraction process according to one embodiment, and FIG. 10B shows an example of deletion candidate registration table 12b according to one embodiment.

Referring to FIG. 10A, deletion control unit 31 can read information on the name of an installed application and a source of the application from application information table 12a (S201). The information on the source of the application is URL from which the application has been downloaded, for example. Deletion control unit 31 can determine whether or not the source of the deletion target application corresponding to deletion icon 106a on which a tap operation has been performed is identical to the source of the installed application having been read (S221).

When the source of the deletion target application is identical to that of the installed application having been read (YES in S221), deletion control unit 31 can store the name and source of this application in deletion candidate registration table 12b (S203). When the source of the deletion target application is not identical to that of the installed application having been read (NO in S221), deletion control unit 31 advances the process to S204.

Similarly to one embodiment, deletion control unit 31 can return the process to S201 to execute the processing of extracting deletion candidates for all of installed applications (S201 to S204).

For example, in application information table 12a shown in FIG. 3A, if a deletion target application is “F”, the applications “A” and “D” obtained from the source identical to that of the application “F” may be registered in deletion candidate registration table 12b shown in FIG. 10B.

As described above, according to one embodiment, deletion candidate applications may be extracted based on the source of a deletion target application. Installed applications assumed to be relevant to the deletion target application, obtained from the source identical to that of the deletion target application, may be extracted as deletion candidates. For example, the image edition application “D” obtained from the source identical to that of the camera application “F” may be extracted as a deletion candidate. A user can collectively delete applications relevant to a deletion target application, obtained from a source identical to that of the deletion target application.

In one embodiment, an application obtained from a source fully matched with that of a deletion target application is extracted as a deletion candidate. An application obtained from a source having high relevance to the source of a deletion target application, such as an application whose information specifying the source thereof, such as URL, is partially different from the source of a deletion target application, may be extracted as a deletion candidate. For example, in application information table 12a shown in FIG. 3A, if a deletion target application is “F”, the application “J” whose information specifying the source thereof is partially identical to the source of the deletion target application “F” may be registered in deletion candidate registration table 12b. A larger number of deletion candidates can thus be extracted.

In one embodiment, a deletion candidate application may be extracted based on information on the maker of an application stored in application information table 12a. In one embodiment, being created by a maker identical to that of a deletion target application shall be a deletion candidate extraction condition for extracting a deletion candidate application.

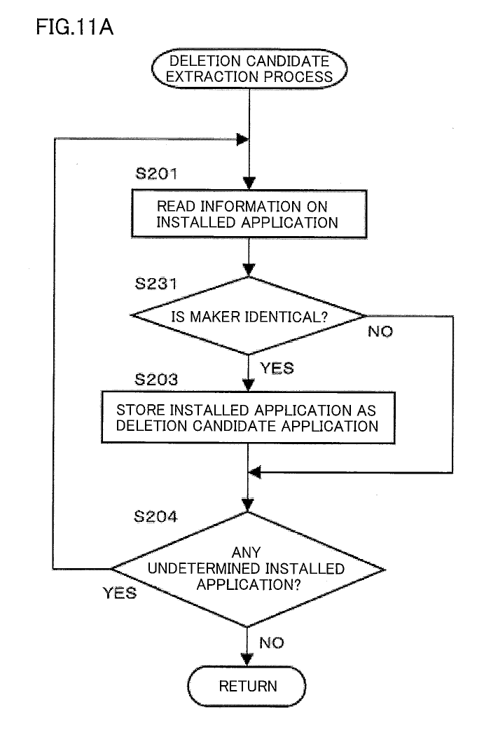

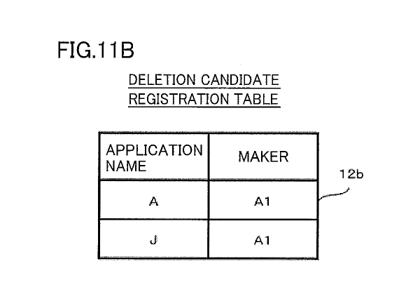

FIG. 11A shows a flowchart of a deletion candidate extraction process according to one embodiment, and FIG. 11B shows an example of deletion candidate registration table 12b according to one embodiment.

Referring to FIG. 11A, deletion control unit 31 can read information on the name and maker of an installed application from application information table 12a (S201). The information on the maker of each application is, for example, an author's name, a company name, and the like of the application. Deletion control unit 31 can determine whether or not the maker of a deletion target application corresponding to deletion icon 106a on which a tap operation has been performed is identical to the maker of an installed application having been read (S231).

When the maker of a deletion target application is identical to that of an installed application having been read (YES in S231), deletion control unit 31 can store the name and maker of this application in deletion candidate registration table 12b (S203). When the maker of a deletion target application is not identical to that of an installed application having been read (NO in S231), deletion control unit 31 advances the process to S204.

Similarly to one embodiment, deletion control unit 31 can return the process to S201 to execute the processing of extracting deletion candidates for all of installed applications (S201 to S204).

For example, in application information table 12a shown in FIG. 3A, if a deletion target application is “F”, the application “J” created by a maker identical to that of the application “F” may be registered in deletion candidate registration table 12b shown in FIG. 11B.

As described above, according to one embodiment, a deletion candidate application may be extracted based on the maker of a deletion target application. An installed application assumed to be relevant to the deletion target application, created by a maker identical to that of the deletion target application, may be extracted as a deletion candidate. For example, the image review application “J” created by a maker identical to that of the camera application “F” may be extracted as a deletion candidate. A user can thereby collectively delete applications relevant to the deletion target application, created by a maker identical to that of the deletion target application.

In one embodiment, an application created by a maker fully matched with that of a deletion target application is extracted as a deletion candidate. An application created by a maker having high relevance to that of a deletion target application, such as an application in which one of a plurality of makers is matched with one of those of a deletion target application, may be extracted as a deletion candidate. In such a case where the maker includes information on the company to which the maker belongs and authors, an application created by a maker matched with a deletion target application only in the company to which the maker belongs may be extracted as a deletion candidate.

The deletion candidate extraction rules of embodiments may be combined appropriately. For example, by combining embodiments, an application whose latest start-up time is close to that of a deletion target application and being obtained from a source identical to that of the deletion target application may be extracted as a deletion candidate application. In this way, by extracting an application that meets all of a plurality of conditions as a deletion candidate, only a deletion candidate having higher relevance can be extracted, and the load of determination whether or not deletion is necessary imposed on a user can be reduced.

For example, by combining embodiments, an application obtained from a source or created by a maker identical to that of a deletion target application may be extracted as a deletion candidate application. In this way, by extracting an application that meets any of a plurality of conditions as a deletion candidate, a larger number of deletion candidates can be extracted.

The deletion candidate extraction rules of embodiments may be changed to various rules based on the information in application information table 12a. For example, an installed application whose installation date and time falls within a predetermined time period from the installation date and time of a deletion target application may be extracted as a deletion candidate application.

As shown in FIG. 4B, embodiments each show a mode of deleting an application associated with start-up icon 106 by performing a tap operation on deletion icon 106a attached to start-up icon 106. In one variation, by moving an application start-up icon 107 to a deletion region, only application start-up icon 107 is deleted, and an application associated with start-up icon 107 is not deleted.

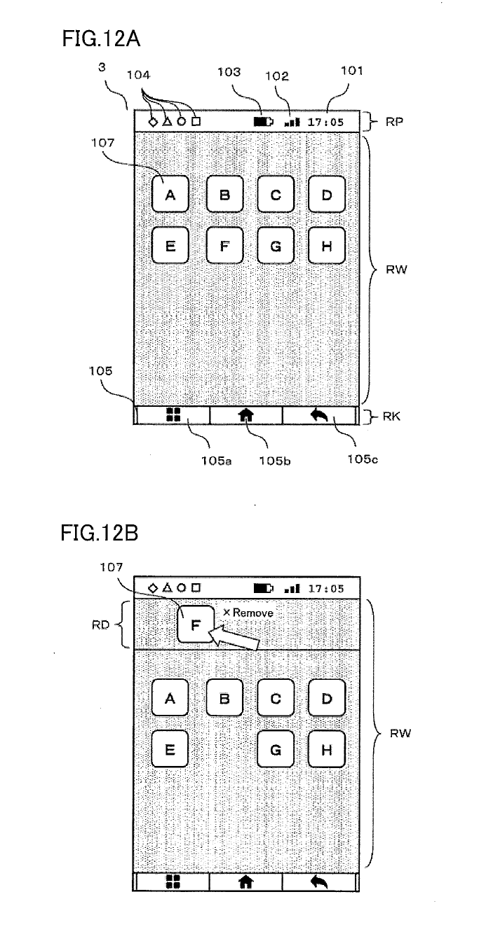

FIGS. 12A and 12B show a home screen according to one variation.

As shown in FIG. 12A, start-up icons 107 corresponding to various types of applications of telephone, e-mail and the like, are arranged on the home screen displayed on display 3.

When a long tap operation is performed on start-up icon 107, the upper part of window region RW is assigned as deletion region RD as shown in FIG. 12B. By performing a drag operation on start-up icon 107 and positioning it in deletion region RD, start-up icon 107 can be deleted. Even if start-up icon 107 is deleted, the application associated with start-up icon 107 is not deleted.

In one variation, mobile phone 1 includes an application for allowing start-up icons 107 of a plurality of applications relevant to an application corresponding to start-up icon 107 a user intends to delete to be deleted collectively in a simple operation. In one variation, start-up icon 107 a user has moved into deletion region RW will be referred to as a “deletion target icon.” In one variation, start-up icon 107 of an application relevant to an application associated with a deletion target icon can be extracted as a “deletion candidate icon.”

In one variation, deletion control unit 31 can collectively delete a deletion target icon and a deletion candidate icon. A control process for deletion of a deletion target icon and a deletion candidate icon will hereinafter be referred to as an “icon deletion process.”

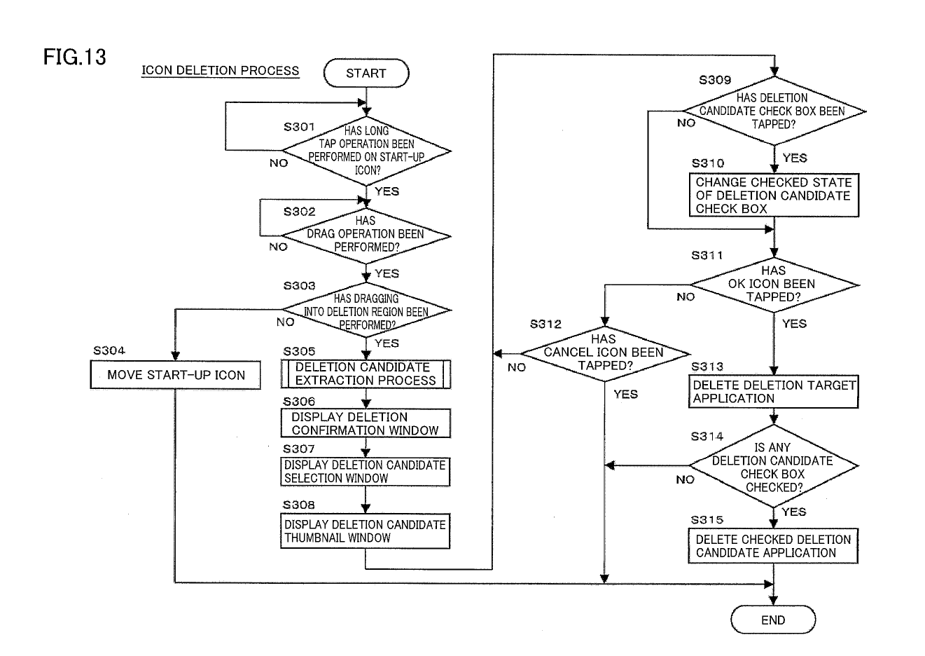

FIG. 13 is a flowchart showing the icon deletion process according to one variation.

Referring to FIG. 13, deletion control unit 31 can determine whether or not a long tap operation has been performed on start-up icon 107 (S301). When a long tap operation has not been performed on start-up icon 107 (NO in S301), deletion control unit 31 can repeat the processing of determining whether or not a long tap operation has been performed on start-up icon 107. When a long tap operation has been performed on start-up icon 107 (YES in S301), deletion control unit 31 can determine whether or not a drag operation has been performed on start-up icon 107 (S302).

When a drag operation has not been performed on start-up icon 107 (NO in S302), deletion control unit 31 can repeat the processing of determining whether or not a drag operation has been performed on start-up icon 107. When a drag operation has been performed on start-up icon 107 (YES in S302), deletion control unit 31 can determine whether or not the drag operation performed on start-up icon 107 is a drag operation in deletion region RD (S303).

When it is not a drag operation in deletion region RD (NO in S303), deletion control unit 31 can move start-up icon 107 to a position in window region RW where a finger has been lifted (S304). Deletion control unit 31 can then terminate the icon deletion process. When the process is terminated, the icon deletion process can be executed again to execute the processing of determining whether or not a tap operation has been performed on start-up icon 107 (S301).

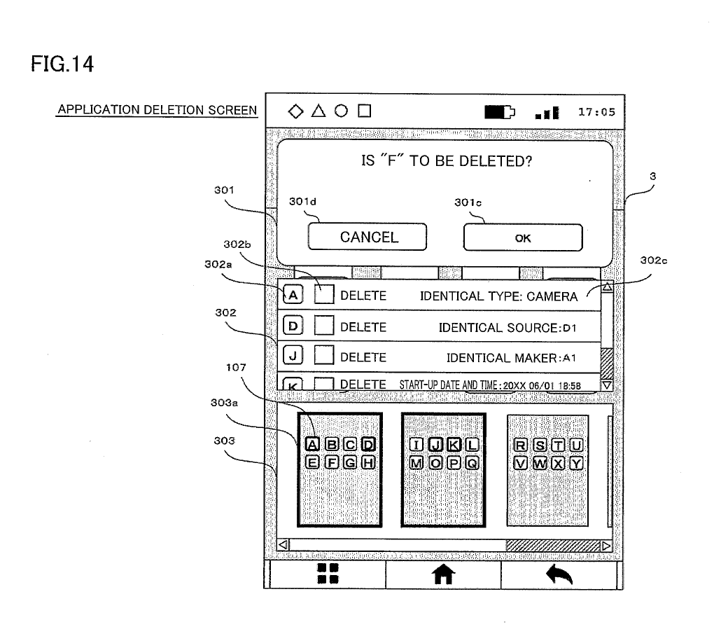

When it is a drag operation in deletion region RD (YES in S302), deletion control unit 31 can execute the deletion candidate extraction process (S305) in a substantially similar manner to embodiments. In the deletion candidate extraction process in one variation, start-up icon 107 of an application relevant to an application associated with a deletion target icon can be extracted as a deletion candidate icon. Deletion control unit 31 can cause display 3 to display deletion confirmation window 301, deletion candidate selection window 302 and deletion candidate thumbnail window 303, as shown in FIG. 14 (S306 to S308).

FIG. 14 shows a display example of an icon deletion screen.

Referring to FIG. 14, the icon deletion screen has a screen configuration which is substantially similar to that of the application deletion screen in embodiments. Deletion confirmation window 301 may include a message confirming whether or not a deletion target icon is to be deleted, an OK icon 301c and a cancel icon 301d.

In the example of FIG. 14, a plurality of extraction reason messages 302c are displayed since a plurality of deletion candidate icons have been extracted based on the plurality of deletion candidate extraction conditions in the deletion candidate extraction process.

Referring back to FIG. 13, deletion control unit 31 can determine whether or not a tap operation has been performed on deletion candidate check box 302b (S309). When a tap operation has been performed on deletion candidate check box 302b (YES in S309), deletion control unit 31 can change the checked state of deletion candidate check box 302b (S310). When a tap operation has not been performed on deletion candidate check box 302b (NO in S309), deletion control unit 31 advances the process to S311.

Deletion control unit 31 can determine whether or not a tap operation has been performed on OK icon 301c in deletion confirmation window 301 (S311). When a tap operation has not been performed on OK icon 301c (NO in S311), deletion control unit 31 can determine whether or not a tap operation has been performed on cancel icon 301d in deletion confirmation window 301 (S312). When a tap operation has not been performed on cancel icon 301d (NO in S312), deletion control unit 31 can return the process to S309 to repeat the processing of determining whether or not a tap operation has been performed on deletion candidate check box 302b in deletion candidate selection window 302 as well as OK icon 301c and cancel icon 301d in the deletion confirmation window (S309 to S312). When a tap operation has been performed on cancel icon 301b (YES in S312), deletion control unit 31 can terminate the icon deletion process. When the process is terminated, the icon deletion process can be executed again to execute the processing of determining whether or not a tap operation has been performed on start-up icon 107 (S301).

When a tap operation has been performed on OK icon 301c (YES in S311), deletion control unit 31 can delete the deletion target icon (S312). In one variation, a program, a configuration file and the like of an application corresponding to a deletion target icon are not deleted, but only start-up icon 107 on the home screen can be deleted.

Deletion control unit 31 can determine whether or not any of deletion candidate check boxes 302b is in the checked state (S314). When any of deletion candidate check boxes 302b is in the checked state (YES in S314), deletion control unit 31 can delete the deletion candidate icon in the checked state (S315). When none of deletion candidate check boxes 302b is in the checked state (NO in S314), deletion control unit 31 can terminate the icon deletion process. When the process is terminated, the icon deletion process can be executed again to execute the processing of determining whether or not a tap operation has been performed on start-up icon 107 (S301).

As described above, according to one variation, a deletion candidate icon of an application relevant to an application corresponding to a deletion target icon can be extracted by deletion control unit 31, and the deletion candidate icon can be automatically deleted after the deletion target icon is deleted. The user can thus delete plurality of start-up icons 107 in a simple operation. This can restrain repetition of a simple deletion operation, and can prevent erroneous deletion of start-up icon 107.

As shown in FIG. 4B, embodiments each show a mode of deleting an application by performing a tap operation on deletion icon 106a attached to start-up icon 106. In one variation, an application can be deleted by an operation on an application setting screen.

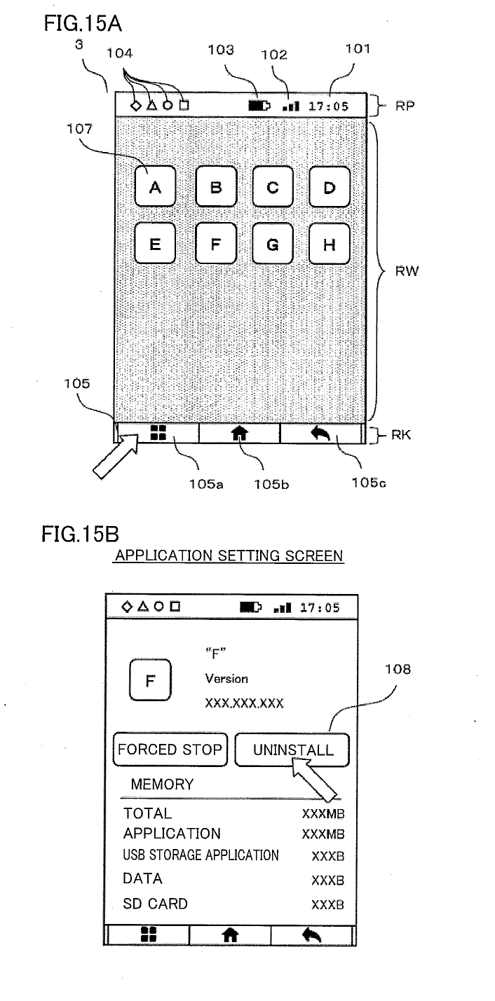

FIG. 15A shows a home screen according to one variation, and FIG. 15B shows the application setting screen according to one variation.

When a tap operation is performed on setting key 105a on the home screen shown in FIG. 15A, a menu selection screen may be displayed. When the item of application setting is selected on the menu selection screen, the application setting screen may be displayed as shown in FIG. 15B.

Various types of information of each application, an uninstall icon 108 and the like may be arranged on the application setting screen. Various types of information on each application may include the contents stored in application information table 12a. Based on these pieces of information, the capacity of memory unit 12 and the like may be displayed on the application setting screen.

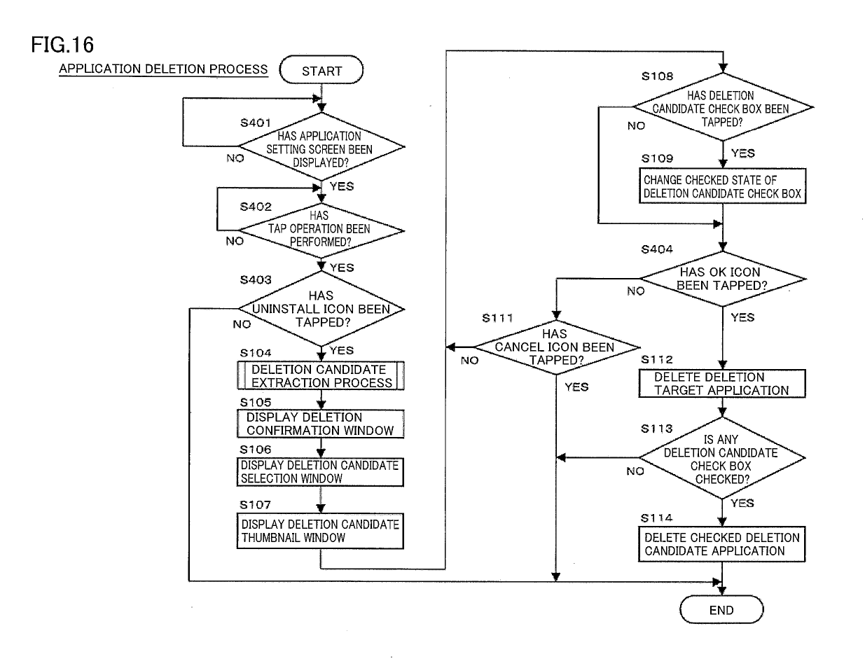

FIG. 16 is a flowchart showing an application deletion process according to one variation.

Referring to FIG. 16, deletion control unit 31 can determine whether or not the application setting screen shown in FIG. 15B has been displayed (S401). Specifically, deletion control unit 31 can determine whether or not the item of application setting has been selected on the menu selection screen displayed by performing a tap operation on setting key 105a on the home screen or the like. When the application setting screen has not been displayed (NO in S401), deletion control unit 31 can repeat the processing of determining whether or not the application setting screen has been displayed. When the application setting screen has been displayed (YES in S401), deletion control unit 31 can determine whether or not a tap operation has been performed (S402).

When a tap operation has not been performed (S402), deletion control unit 31 can repeat the processing of determining whether or not a tap operation has been performed. When a tap operation has been performed (YES in S402), deletion control unit 31 can determine whether or not the operation performed is a tap operation on uninstall icon 108 (S403).

When it is not a tap operation on uninstall icon 108 (NO in S403), deletion control unit 31 can terminate the application deletion process. When it is a tap operation on uninstall icon 108 (YES in S403), deletion control unit 31 can execute the deletion candidate extraction process similarly to one embodiment (S104), and can display each window for deletion candidate selection (S105 to S107).

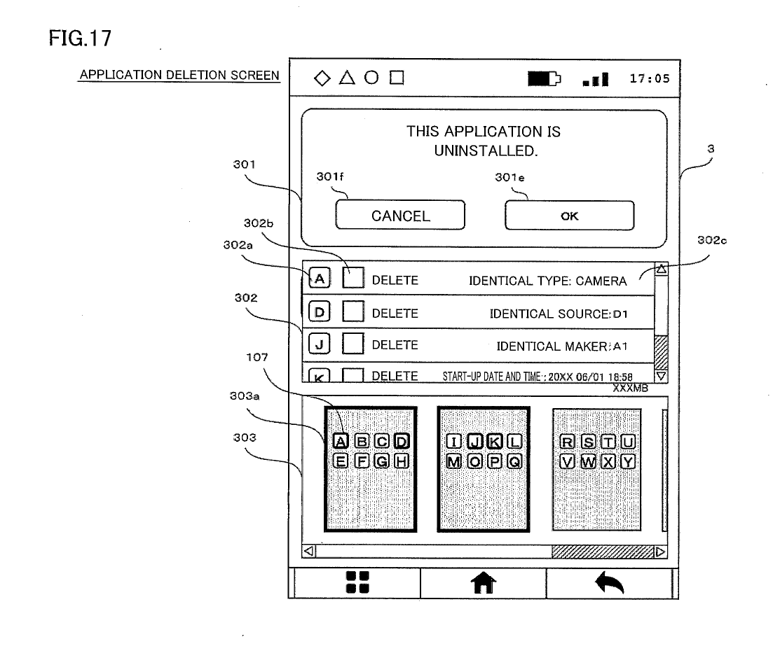

FIG. 17 shows a display example of an application deletion screen according to one variation.

Similarly to embodiments, the application deletion screen may include deletion confirmation window 301, deletion candidate selection window 302 and deletion candidate thumbnail window 303. Deletion confirmation window 301 may include an OK icon 301e and a cancel icon 301f.

Referring back to FIG. 16, deletion control unit 31 can execute the process for deleting a deletion target application and a deletion candidate application in accordance with operations on the application deletion screen, similarly to one embodiment (S105 to S114). In one variation, the processing of determining deletion icon 301a (S110) is replaced by processing of determining on OK icon 301e (S404).

As described above, according to one variation, effects substantially similar to those of one embodiment are achieved.

Both of the deletion mode of embodiments and that of one variation may be employed simultaneously. Alternatively, both of the deletion mode of embodiments and that of one variation may be employed simultaneously. Furthermore, the deletion mode of embodiments, that of one variation, and that of another variation may be employed simultaneously. Accordingly, by whichever deletion means a user intends to delete an application or start-up icon 107, the application itself or an application for which start-up icon 107 becomes a deletion candidate can be presented.

In embodiments and one variation, deletion candidate selection window 302 is displayed on the application deletion screen before the process of deleting a deletion target application. In one variation, deletion candidate selection window 302 may be displayed after a deletion target application is deleted. In the case of one variation, when a predetermined time period has passed after a deletion target application is deleted, deletion candidate selection window 302 may be automatically hidden.

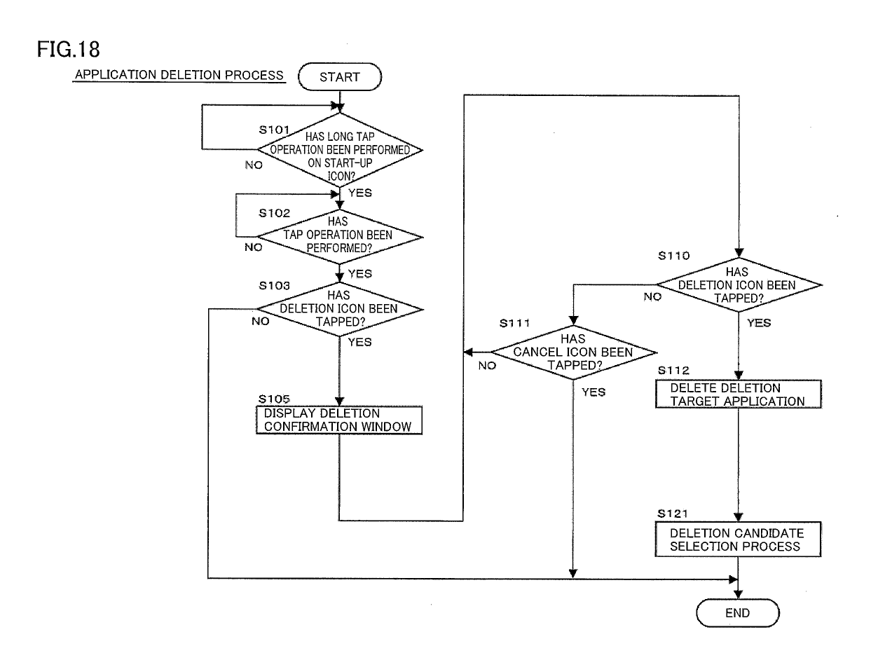

FIG. 18 is a flowchart showing an application deletion process according to one variation. In the flowchart of FIG. 18, the processing of S104 and S106 to 109 as well as the processing of S113 to S114 in the flowchart according to one embodiment shown in FIG. 5 have been deleted, and processing of S121 has been added.

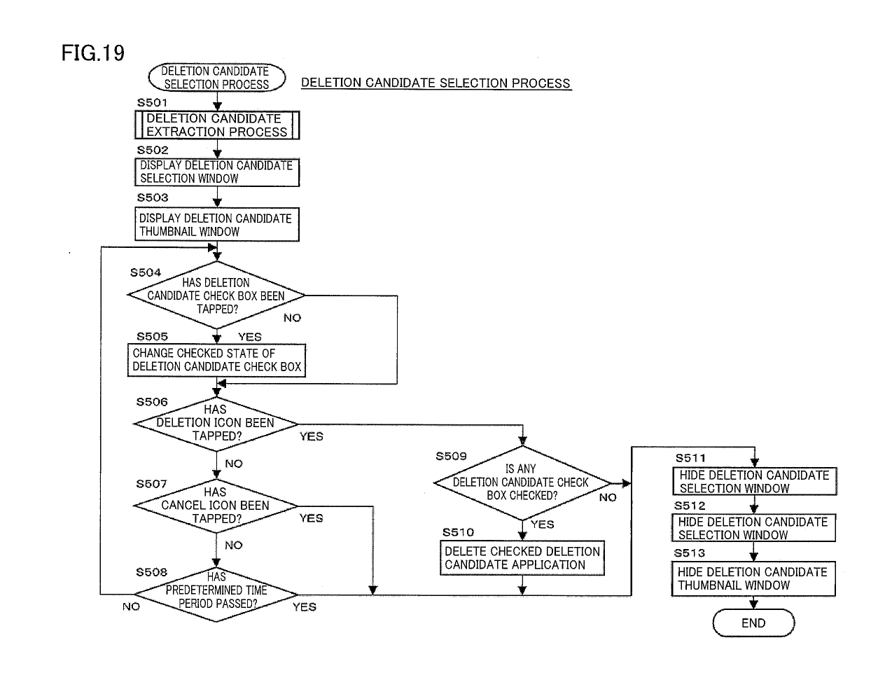

When a tap operation is performed on deletion icon 106a on the home screen (YES in S103), deletion control unit 31 can cause deletion confirmation window 301 to be displayed without performing the deletion candidate extraction process (S105). Deletion control unit 31 can determine whether or not a tap operation has been performed on deletion icon 301a in deletion confirmation window 301 (S110). When a tap operation has been performed on deletion icon 301a (YES in S110), deletion control unit 31 can delete a deletion target application (S112), and can execute the deletion candidate selection process shown in FIG. 19 (S121).

FIG. 19 is a flowchart showing a deletion candidate selection process according to one variation.

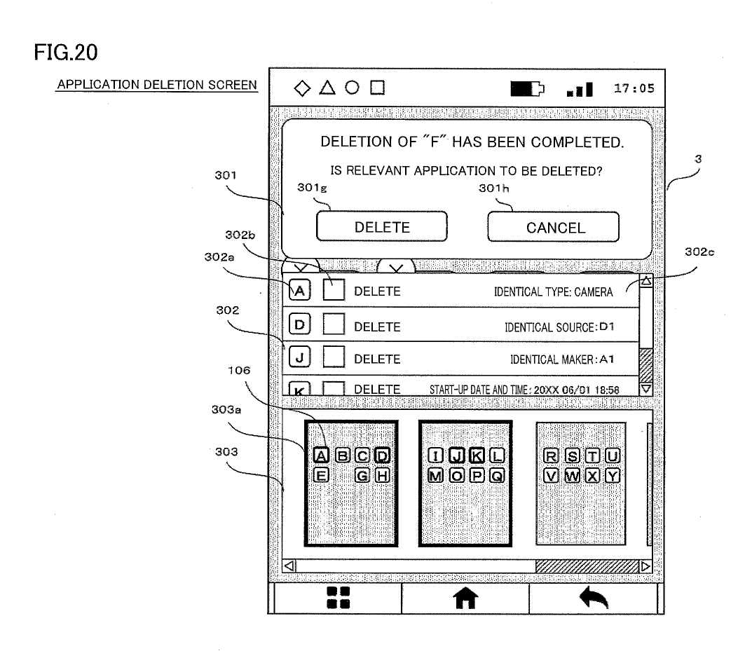

Referring to FIG. 19, deletion control unit 31 can execute a deletion candidate extraction process similarly to one embodiment (S501). Deletion control unit 31 can cause display 3 to display deletion candidate selection window 302 and deletion candidate thumbnail window 303 (S502, S503), as shown in FIG. 20.

FIG. 20 shows a display example of an application deletion screen according to one variation.

Referring to FIG. 20, the application deletion screen may include deletion confirmation window 301, deletion candidate selection window 302 and deletion candidate thumbnail window 303. Deletion confirmation window 301 may include a message saying that a deletion target application has been deleted, a message confirming whether or not a deletion candidate application is to be deleted, a deletion icon 301g, and a cancel icon 301h.

Referring back to FIG. 19, deletion control unit 31 can determine whether or not a tap operation has been performed on deletion candidate check box 302b (S504). When a tap operation has been performed on deletion candidate check box 302b (YES in S504), deletion control unit 31 can change the checked state of deletion candidate check box 302b (S505). When a tap operation has not been performed on deletion candidate check box 302b (NO in S504), deletion control unit 31 advances the process to S506.

Deletion control unit 31 can determine whether or not a tap operation has been performed on deletion icon 301g in deletion confirmation window 301 (S506). When a tap operation has not been performed on deletion icon 301g (NO in S506), deletion control unit 31 can determine whether or not a tap operation has been performed on cancel icon 301h in deletion confirmation window 301 (S507). When a tap operation has not been performed on cancel icon 301h (NO in S507), deletion control unit 31 can determine whether or not a predetermined time period has passed after deletion confirmation window 301 is displayed (S508).

When the predetermined time period has not passed after deletion confirmation window 301 is displayed (NO in S508), deletion control unit 31 can return the process to S504 to repeat the processing of determining whether or not a tap operation has been performed on each icon or the like (S504 to S507). When the predetermined time period has passed with no tap operation performed on deletion icon 301g (YES in S508), or when a tap operation has been performed on cancel icon 301h (YES in S507), deletion control unit 31 can hide deletion confirmation window 301, deletion candidate selection window 302 and deletion candidate thumbnail window 303 (S511 to S513), and can terminate the deletion candidate selection and deletion process.

When a tap operation has been performed on deletion icon 301g (YES in S506), deletion control unit 31 can determine whether or not any of deletion candidate check boxes 302b is in the checked state (S509). When any of deletion candidate check boxes 302b is in the checked state (YES in S509), deletion control unit 31 can delete the deletion candidate application in the checked state (S510). When none of deletion candidate check boxes 302b is in the checked state (NO in S509), deletion control unit 31 can hide deletion confirmation window 301, deletion candidate selection window 302 and deletion candidate thumbnail window 303 (S511 to S513), and can terminate the deletion candidate selection and deletion process.

As described above, according to one variation, effects substantially similar to those of one embodiment are achieved.

According to one variation, deletion candidate selection window 302 and the like are automatically hidden when a predetermined time period has passed after deletion candidate selection window 302 is displayed. A user does not need to perform an operation of closing deletion candidate selection window 302 and the like even when deletion of a deletion candidate application is unnecessary, which reduces user's time and effort.

Although embodiments and variations of the present disclosure have been described above, the present disclosure is not at all restricted by embodiments or the like. Various modifications can also be made to embodiments of the present disclosure, in addition to those described above.

For example, although embodiments and one variation show the mode of deleting an application associated with start-up icon 106 and start-up icon 107, the present disclosure may be applied to a mode of deleting a widget or the like. A widget is a display object that causes a result of execution of some function of an application to be displayed on the home screen (e.g., calendar, weather report or the like).

In this case, first, a widget to be a deletion target may be selected from among a plurality of widgets arranged on the home screen. A widget of an application relevant to an application corresponding to the selected widget is extracted, and the selected widget and the extracted widget are collectively deleted. Then, a user can delete a plurality of widgets in a simple operation.

The screen display in each of embodiments and variations is an example, and this is not a limitation. For example, instead of deletion confirmation window 301, deletion candidate selection window 302 and deletion candidate thumbnail window 303 being displayed in individual window regions, a confirmation screen having the same functions as these windows 301 to 303 may be displayed on the whole window region RW of display 3. Extraction reason message 302c can also be changed freely.

Although in embodiments and variations, deletion confirmation window 301, deletion candidate selection window 302 and the like are displayed, display of these windows 301 to 303 may be omitted, and when a deletion target application is deleted, all of deletion candidate applications may be deleted automatically.

In embodiments, a deletion target application is stored in memory unit 12 of mobile phone 1, but may be stored in an external storage medium or a memory unit of an electronic device (e.g., personal computer, server, etc.) other than mobile phone 1 capable of communicating with mobile phone 1. In embodiments, application information table 12a and deletion candidate registration table 12b for extracting a deletion candidate application are stored in memory unit 12 of mobile phone 1, but may be stored in an external storage medium or a memory unit of an electronic device (e.g., personal computer, server, etc.) other than mobile phone 1 capable of communicating with mobile phone 1.

The present disclosure is not limited to a mobile phone, but is also applicable to a mobile terminal device, such as a personal computer, a PDA (Personal Digital Assistant), a tablet PC and a digital book terminal. Furthermore, the present disclosure is not limited to a mobile terminal device, but is applicable to various types of electronic devices including a personal computer and the like.

Although the present disclosure has been described and illustrated in detail, it is clearly understood that the same is by way of illustration and example only and is not to be taken by way of limitation, the scope of the present disclosure being interpreted by the terms of the appended claims.

1. An electronic device comprising:
a memory configured to store applications comprising a first application and one or more second applications; and at least one processor configured to
select the first application,
identify the one or more second applications relevant to the first application,
delete the first application, and
delete the one or more second applications when the first application is deleted.

2. The electronic device according to claim 1, wherein
the first application is different from the one or more second applications.

3. The electronic device according to claim 1, wherein
the at least one processor is configured to identify the one or more second applications based on types of the one or more second applications.

4. The electronic device according to claim 1, wherein types of the one or more second applications correspond to a type of the first application.

5. The electronic device according to claim 1, wherein
the at least one processor is configured to identify the one or more second applications based on one or more start-up dates and times of the one or more second applications.

6. The electronic device according to claim 1, wherein one or more start-up dates and times of the one or more second applications are within a predetermined range relative to the latest start-up date and time of the first application.

7. The electronic device according to claim 1, wherein
the at least one processor is configured to identify the one or more second applications based on one or more sources of the one or more second applications.

8. The electronic device according to claim 1, wherein one or more sources of the one or more second applications correspond to a source of the first application.

9. The electronic device according to claim 8, wherein
the source of the first application and the one or more sources of the one or more second applications are at least part of the URL for downloading the first application and the one or more second applications.

10. The electronic device according to claim 1, wherein
the at least one processor is configured to identify the one or more second applications based on one or more makers of the one or more second applications.

11. The electronic device according to claim 1, wherein one or more makers of the one or more second applications correspond to a maker of the first application.

12. The electronic device according to claim 1, further comprising a display, wherein
the at least one processor is configured to cause the display to display a first screen including a first object operated to start up the first application and one or more second objects operated to start up the one or more second applications, and
the at least one processor is configured to delete the first object and the one or more second objects following deletion of the first application and the one or more second applications.

13. The electronic device according to claim 12, wherein
the at least one processor is configured to display a second screen to determine one or more third applications from among the one or more second applications on the display, and wherein
if one or more third applications are determined, the at least one processor is configured to prevent to delete the one or more third applications when the one or more second applications are deleted.

14. The electronic device according to claim 13, wherein the at least one processor is configured to cause information indicating a display positions of each the one or more second objects on the first screen to be displayed on the second screen.

15. The electronic device according to claim 12, wherein the at least one processor is configured to cause a second screen to be displayed before the at least one processor deletes the first application.

16. An electronic device comprising:
a display;
a memory configured to store applications comprising a first application and one or more second applications; and
at least one processor configured to
cause the display to display a first screen including a first object operated to start up the first application and one or more second objects operated to start up the one or more second applications,
select the first application,
identify the one or more second applications relevant to the first application,
delete the first application,
delete the one or more second applications when the first application is deleted, and
delete the first object and the one or more second objects following deletion of the first application and the one or more second applications.

17. A method for controlling an electronic device including a memory configured to store applications comprising a first application and one or more second applications, comprising the steps of:
selecting the first application;
identifying the one or more second applications relevant to the first application;
deleting the first application; and
deleting the one or more second applications when the first application is deleted.
